(19) United States
(12) Patent Application Publication
(10) Pub. No.: US 2006/0244421 A1
(43) Pub. Date: Nov. 2, 2006

(54) Method and apparatus of extracting residual charge from energy storage device

(76) Inventors: Kailas Narendran, South Burlington, VT (US); John McBean, Boston, MA (US)

Correspondence Address: Joseph P. Quinn, Esq.;Brown Rudnick Berlack Israels LLP, One Financial Center, Boston, MA, 02111, US

(21) Appl. No.: 11/401,571

(22) Filed: Apr. 11, 2006

Related U.S. Application Data
(60) Provisional application No. 60/671,071, filed on Apr. 14, 2005.

(51) Int. Cl. H02J 7/00

(52) U.S. Cl. 320/132

(57) ABSTRACT

A method and apparatus which enables, regulates, controls, and monitors the flow of energy from “source cells” to “target cells”, for the purpose of harvesting otherwise wasted energy from the source cells, and using that energy to charge the target cells. Embodiments also provide audio, tactile, and/or visual user feedback regarding the status of the system, of its components, and of the individual cells.

### CROSS REFERENCE TO RELATED APPLICATIONS

This application claims priority to U.S. Provisional Application No. 60/671,071 filed Apr. 14, 2005.

### FIELD OF THE INVENTION

The present invention relates to energy storage devices and more particularly to extracting residual energy from partially depleted energy storage devices.

### BACKGROUND OF THE INVENTION

During operation, primary cell batteries are used in a variety of devices. Batteries decrease in energy capacity as they are used. As a result of battery chemistry and construction, over the course of the lifetime of a battery, the power output of the cell decreases. The result is that when partially depleted batteries are used in high current consumption devices, their out put voltage can decrease, and render them unusable.

FIG. 1, which was taken from a datasheet of a common primary alkaline cell and which shows cell output voltage under constant power discharge, is an example of this effect.

Under a constant power discharge, the output voltage of the cell decreases over its operation time. The result of this effect is that a battery which is advanced in service minutes will not be able to provide the same voltage as a newer battery, given the same power draw from the cell.

FIGS. 2 and 3, show the output voltage of a AA cell (taken from the datasheet) under a constant current draw. These graphs also demonstrate that the available voltage, at a specified current level decreases over time (also as illustrated in FIG. 1).

The voltage provided by battery cells is required for proper operation of electronic devices. Once a battery is unable to provide a sufficient voltage for operation of a device due to the aforementioned affects (decreasing power output over service life), it may not be suitable for use in a device of that power level. It may still, however, be possible to use the battery in a lower power device for a longer period of time.

For example, assume the cell used in the generation of FIG. 1 was put into a 500 mW device that required at least 1.3 volts from the battery for normal operation. According to the graph, the device would stop operating at the time indicated by marker A. If the battery was then moved to a device with a 250 mW power consumption, that device could continue to operate until time indicated by marker B.

The effects above illustrate that the inability of a battery to provide sufficient voltage for operation of a high power device does NOT indicate that the battery is out of useful energy (synonymous to—“empty”, or “dead”)!

The amount of energy residual in the battery cell is given by the equation
energy=∫Power(t)dlt

Embodiments of this invention extract the residual energy from a partially depleted cell at a low rate (low power). That energy is then imparted to another, rechargeable, cell.

For example, assume a user starts with a few partially depleted AA alkaline cells, and one rechargeable AA cell that are all too depleted to power a 500 mW device. Embodiments of this invention may be used to transfer the residual energy from the alkaline cells into the rechargeable cell. When the rechargeable cell has enough energy imparted, it can provide enough voltage for the operation of the 500 mW device.

Another reason for premature disposal of batteries is simply the lack of certainty that a particular cell, or set of cells contains enough energy to perform a task for the desired length of time. For example, if a user takes a flashlight with him on a task that is to last 36 hours, and the flashlight he picks up turns on, he has no way of knowing if the batteries inside are 100% full or only 60% full. To be safe, the user will discard the “unknown” batteries and replace them with fresh ones. This disposal of “unknown” batteries is a source of great waste. Embodiments of the present invention would harvest the remaining energy from such “unknown” batteries before their disposal.

In many situations, a failure in equipment has a high cost. As a result, batteries are discarded prematurely (before they are unable to power the device they are being used with), or as soon as the low battery indicator illuminates. Especially when batteries are used with high power devices, a large amount of energy is wasted in this preemptive disposal process.

### SUMMARY OF THE INVENTION

Illustrative embodiments of the present invention provide a device which enables, regulates, controls, and monitors the flow of energy from “source cells” to “target cells”, for the purpose of harvesting otherwise wasted energy from the source cells, and using that energy to charge the target cells. Embodiments of the device also provide audio, tactile, and/or visual user feedback regarding the status of the system, of its components, and of the individual cells.

Embodiments of this invention are specifically designed for easy and reliable operation. This can be accomplished by providing indicators on individual cells in the system that provide quick feedback to the operator regarding the state of charge of each cell in the system. Additionally, an external indicator can be provided that indicates the general state of operation of the system, allowing the user to avoid opening the case to check if energy transfer is occurring or not.

Most heretofore known battery recharging devices require an external source of energy to accomplish charging. Illustrative embodiments of this invention use the partially depleted cells as that source of energy.

In particular embodiments, the portable and energy harvesting nature of this system require that indication be provided as to the state(s) of the energy source(s), as well as the state(s) of the target cell(s) that are being charged.

### BRIEF DESCRIPTION OF THE DRAWINGS

The present invention will be more fully understood from the following detailed description of illustrative embodiments taken in conjunction with the accompanying drawings in which:

FIG. 1 is a graphic depiction of comparative battery cell discharge rates according to the prior art;

FIG. 2 is a graphic depiction of a battery cell discharge rate in a tape player as known in the prior art;

FIG. 3 is graphic depiction of a battery cell discharge rate in electronic devices as known in the prior art;

FIG. 4 is a system block diagram of an apparatus for extracting residual charge from energy storage devices according to illustrative embodiments of the present invention;

FIG. 5 is a mechanical drawing of an apparatus for extracting residual charge from energy storage devices according to illustrative embodiments of the present invention;

FIG. 6 is schematic system diagram demonstrating an configuration and algorithm for system powering, operating and charging according to an illustrative embodiment of the present invention;

FIG. 7 is a flow diagram for operating an apparatus for extracting residual charge from energy storage devices according to illustrative embodiments of the present invention;

FIG. 8 is a process flow diagram depicting a method for extracting residual charge from energy storage devices according to illustrative embodiments of the present invention;

FIG. 9 is a schematic block diagram of an apparatus for extracting residual charge from energy storage devices according to illustrative embodiments of the present invention; and

FIG. 10 is a schematic circuit diagram depicting charging circuitry used in at least one illustrative embodiment of the present invention.

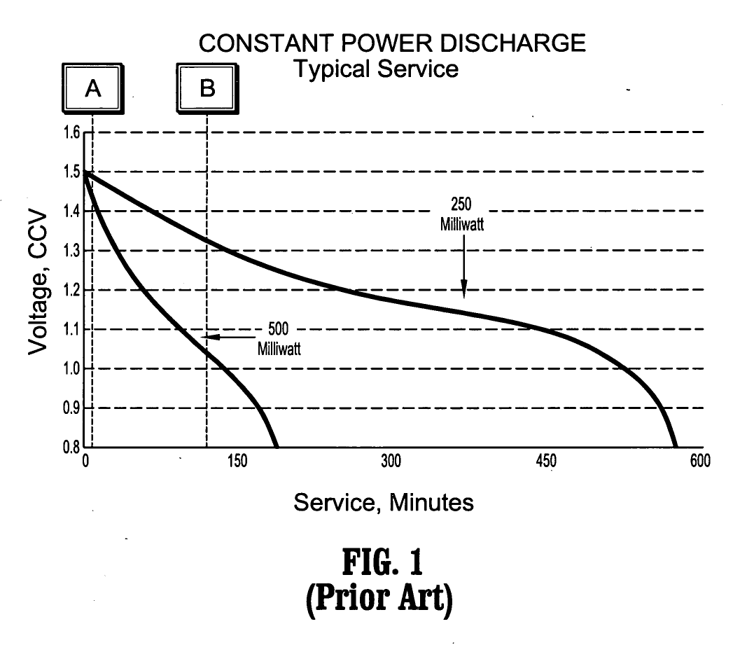

### DETAILED DESCRIPTION

The terms “source cells”, or “sources” are used to describe the batteries from which energy is being harvested in the proposed system. “Source cells” may be batteries of any size (AAA, AA, A, C, D, military radio batteries, etc) and of any chemistry (Alkaline, Nickel metal hydride, Lithium Polymer, Lithium ion, Nickel Cadmium, Lead Acid, Hydrogen fuel cells, Lithium, etc). When inserted in the system, source cells may be in a series or parallel configuration.

The terms “target cells”, or “targets” are used to describe the batteries to which energy is being transferred in the proposed system. “Target cells” may be batteries of any size (AAA, AA, A, C, D, military radio batteries, etc) and of a variety of chemistries (Alkaline, Nickel metal hydride, Lithium Polymer, Lithium ion, Nickel Cadmium, Lead Acid, Hydrogen fuel cells, Lithium, etc). The “Target cells” in the proposed system are cells which can be re-charged. When inserted in the system, target cells may be in a series or parallel configuration.

The term “controller” is used to describe the set of components which regulates, controls, monitors, and adjusts the flow of energy between the source cells and target cells in the proposed system. The “controller” also monitors itself and other components of the system, and controls the user interface, which provides the user with information about the status of the individual cells, the system, and its components.

The term “state of charge” is used to refer to the amount of energy in a cell in the system. State of charge measured by the system proposed may not perfectly match the actual state of charge. Units for the state of charge may be units of charge (for example coulombs).

The term “e-switch” is used to refer to a device that can stop or start the flow of electrical energy. Examples of e-switches are mechanical switches, reed switches, sensing elements (ie—magnetic field sensors, current sensors, environmental sensors, acceleration sensors, etc.). An e-switch may have a threshold function, a linear function, a non-linear function, or a step function as its input and/or output.

In illustrative embodiments of the invention, a user places source cells in the appropriate locations on the device. The source cells may be cells that would otherwise have been discarded due to a lack of sufficient energy, or a lack of certainty about their energy content. The user also places target cells in the appropriate locations on the device. The target cells are rechargeable cells which can receive and retain at least some part of the energy transferred to them from the source cells, via the controller. With at least 1 source and 1 target cell in place, the controller controls the rate of flow of energy from source cells to target cells, such that the source cells become more depleted and the target cells gain energy. The number of source cells and target cells is variable and ranges from 1 source and 1 target to an arbitrarily large number of each.

During operation, a user interface can provide sensory (visual, tactile, and/or auditory) feedback regarding the status of the system as a whole, of its individual parts, and of the individual cells (sources and targets) in the system. The feedback may be in the form of lights or LEDs (light emitting diodes), speakers or buzzers, or vibratory tactile sensors, for example. In one embodiment, the device provides a system-level feedback that is accessible at a quick glance (in the form of a single light on the outside of the enclosure), while individual indicators indicate the status of each cell, but are only activated when the enclosure is opened. Such a design minimizes energy consumption of the indicators, while simplifying the user interface. In another design, all indicators are visible from the outside of the enclosure, so all aspects of feedback (regarding system, and the individual cells) are accessible without opening the enclosure. In another design, all indicators are accessible only by opening the enclosure. In each case, the indicators may be on all the time, or the indicators may be activated by pushing a button or switch, or squeezing, shaking, holding, or covering a particular part of the enclosure, so as to only turn on the indicators when user feedback is desired. Such an enabling, or “turning on” of the indicators may also be achieved automatically upon opening or removing the lid of the enclosure, for example.

In one example, the user interface may be comprised of multi-colored LEDs. Information is conveyed to the user by changing the color of each LED, its blinking frequency, its blinking duty cycle, or by changing any combination thereof. For example, steady green may indicate the system is charging, while blinking red may indicate there is a problem. For a particular cell, steady green may indicate that a cell still contains a substantial amount of energy; steady yellow may indicate a partially depleted cell; and steady red may indicate a fully depleted cell. Extinguished, or blinking red may indicate a missing cell.

A system status indicator may provide information about the status of the system. Such an indicator could have output modes that indicate that the system is charging, not charging, or experiencing an error. The status indicator may also indicate a device failure, or an individual cell failure or problem. The status indicator may also provide diagnostic information pertaining to the charging rate, system current, charge history, charge time remaining, elapsed time, temperature, system settings, self-diagnostic state, or cell test results. The status indicator may consist of single or multiple lights, speakers or other output devices, and may be readable when the enclosure is open or closed, or both.

Individual cell indicators may provide information about the status of the system, as well as providing information about the individual cells. Cell indicators may provide feedback on all of the same parameters as the status indicator, while also indicating any or all of the following: energy level in each cell, individual cell voltage, group cell voltage, cell damage or anomaly, cell in self-test mode, elapsed time or time remaining, cell polarity incorrect (cell inserted upside down), no cell present, cell requiring replacement, cell current, correct or incorrect cell chemistry, or cell charge status.

Illustrative embodiments of the present invention can house some number of source cells and target cells, as well as the components of the controller and user interface. The enclosure can be designed to protect the various components of the system from weather, dirt, dust, water, and perhaps to minimize its visibility. The enclosure may also serve to hold the cells in place to minimize shifting of the cells during impacts. The enclosure may be constructed from metal, plastic, wood, composite material, or any combination thereof. The enclosure is openable by the user, and is held shut by snaps, latches, buckles, straps, hook-and-loop, zippers, buttons, or threaded components (a screw-on top, for example), or any combination thereof. The enclosure may be waterproof. The enclosure may also be designed to protect the system, its components, and the cells it contains from damage during impact. In one design, the enclosure contains an integral switch (magnetic, mechanical, or optical) which activates the user interface LEDs upon opening the lid. The mechanical system may be expandable, enabling the addition of modular units, to increase total cell throughput. The system may also be designed to interface with an external device, power source, or energy storage system, enabling the use of such an external device or system as either a source or target in the system. This could be useful, for example, for use of the device with batteries (as sources or as targets) that are too large to fit inside the mechanical enclosure.

The user interface may be connected to the system using a wireless connection. In one example, the aforementioned indicator of system state is displayed on a heads up display worn by the user. In another example, the aforementioned indicator of system state is displayed at a remote location, receiving information from multiple systems.

During operation, the controller can increase applied voltage and/or current to the cells in the system to a level sufficient to enable charging, monitor cell state, monitor and control charging rate, drive the user interface, and ensure safe and efficient operation. System powering components can provide voltage and current to the system. components including the controller and user interface.

In one example, the system powering component is an energy storage cell. Energy storage cells may be batteries of any size (AAA, AA, A, C, D, military radio batteries, coin cells, button cells, etc) and of a variety of chemistries (Alkaline, Nickel metal hydride, Lithium Polymer, Lithium ion, Nickel Cadmium, Lead Acid, Hydrogen fuel cells, Lithium, etc).

In one example, the system powering component is a voltage converter that uses at least one magnetic storage element, and delivers power from a primary energy source such as a source cell, a target cell, a photovoltaic cell, or an internal energy storage device. This voltage converting topology may include, but is not limited to, boost converters, buck converters, and transformers.

In one example, the system powering component is a voltage converter that uses at least one capacitive storage element and delivers power from a primary energy source such as a source cell, a target cell, a photovoltaic cell, or an internal energy storage device. This voltage converting topology may include, but is not limited to, charge pumps.

In one example, the system powering component is comprised of a plurality or combination of the aforementioned configurations. One example is a magnetic or capacitive storage element voltage converter on every cell in the system (both sources and targets). This allows the system to turn on if a cell of appropriate capacity, charge level, and voltage is inserted into any spot (source or target). One example is a magnetic or capacitive storage element voltage converter on a select number of cells in the system, such that only if any one of those cells is inserted, the system will turn on.

In one example, the system powering component is comprised of an element which converts radiant energy to electrical energy using photogenerated charge carriers. Examples of these elements are photovoltaic cells.

In one example, the system powering component is comprised of an element which converts radiant energy to electrical using absorbed heat and a junction that converts heat into electricity. Examples of these elements are a dark surface that absorbs heat, connected to a thermocouple.

One component of the controller, called the charging power component, is a component that provides voltage and current sufficient for powering the charging components.

In one example, the charging power component is a voltage converter that uses at least one magnetic storage element, and delivers power from single or multiple source cells. This voltage converting topology may include, but is not limited to, boost converters, buck converters, and transformers.

In one example, the charging power component is a voltage converter that uses at least one capacitive storage element, and delivers power from single or multiple source cells. This voltage converting topology may include, but is not limited to, charge pumps.

In one example, the charging power component is comprised of a plurality or combination of the aforementioned configurations. One example is a magnetic or capacitive storage element voltage converter on every source cell in the system. This allows the system to accomplish charging of the target cells if a source cell of appropriate capacity, charge level and voltage is inserted in the appropriate slot, and if there is at least target in the appropriate spot in the system. Another example is a magnetic or capacitive storage element voltage converter on a select number of source cells in the system, such that only if at least one of those cells is inserted, charging of the target(s), if present, can commence.

In one example, the charging power component is comprised of a series connection of the source cells. An e-switch can be used to regulate how many series cells are used to provide the energy for charging power. For example, if there are four cells in series, A, B, C, and D, the charging power component may have an e-switch connected to the node of interconnection between cells A&B, B&C, C&D and the open end of D.

In some embodiments, the charging power component and the system powering component are the same physical element. The step up voltage element that provides a voltage capable of charging the targets can also provide power to the rest of the system. In this case, the system powering component from the targets may be connected such that its output doesn't act as a charging power component.

During operation of the device according to illustrative embodiments of the present invention, the charging control component adjusts the rate of energy being transferred into the target(s). The energy for the charging control component comes from the charging power component. The charging control component may also determine the rate of energy transfer during charging and provide that information as an output for the rest of the system.

In one example, the charging control component is a voltage converter that uses at least one magnetic storage element. This voltage converting topology may include, but is not limited to, buck converters, boost converters, and transformers.

In one example, the charging control component is a voltage converter that uses at least one capacitive storage element. This voltage converting topology may include, but is not limited to, charge pumps.

In one example, the energy controlled by the charging control component can be directed to a singular or multiple target cell(s) using an e-switch which is controlled by the charge monitoring component.

In one example, the charging control component is a linear dissipative element that may be able to be selected, automatically or manually, from an array of such elements connected to e-switches which can program a specific rate of energy transfer. Examples of such linear elements are linear voltage regulators (ie—LM317, 7805 voltage regulator, etc), and resistors.

In one example, the charging control component can monitor the rate of energy transfer using a small dissipative element (ie—resistor) in series with the cell or cells being charged, and can measure the voltage drop across the element.

In one example, the charging control component can monitor the rate of energy transfer using an element that senses the magnetic field resulting from the flow of energy.

During operation of the device according to the illustrative embodiments of the present invention, a charge monitoring component monitors the state of all the cells in the system (source cells and target cells) and controls the charging of the target cells accordingly. If the powering component is an energy storage cell, the charge monitoring component may monitor its state as well.

One example of a charge monitoring component is a microcontroller. Examples of microcontrollers are the PIC18F452, Atmel processors, etc.

In at least one embodiment of the present invention, a sub-component of the charge monitoring component, called a charge progress component, determines the actual state of charge for all cells during the charging process, and updates the user interface with the appropriate information.

The charge monitoring component may also monitor additional parameters such as time, cell temperature, environmental parameters, mechanical state of system (for example, accelerations, altitude in space, etc.), and other parameters related to the operation and state of the system.

Systems may be interconnected via physical or wireless connections, that enable individual units to have knowledge of the state of units they are connected to. In one example, units A and B are connected. The system monitoring component of system A may be able to know and control the charging control component of system B. In addition, the user interface of system B may provide information about the cells in system A. If the aforementioned connection is physical (wired), system A may be able to use the charging power from system B to charge its target cells.

One example of a charge progress component is a system that monitors the energy going into the target cells. Once a specified amount of energy has been imparted to the cells, the charge monitoring component may stop the charging of the cell or cells. This can be accomplished by integrating the current that is traveling into the cell or cells.

The charging of the target cells may occur in series or parallel. In one example, the system charges the target cells sequentially, in order of insertion. In one example, the system charges the target cells sequentially, filling the most-full cell first, and the least full cell last. In one example, the system charges the target cells sequentially, in a random order. In one example, the system charges one or more of the targets simultaneously. In one example, the system charges multiple targets simultaneously, but changes the specific targets over time even before they are full.

One example of a charge progress component is a system that applies a known load to the cell being tested. One known load test can be accomplished using a resistor (or other dissipative element) in series with an electrical switch (physical or electronically actuated) to ground. When the switch is changed to a conductive state, the cell is under a known load, and measurement of the resulting voltage drop across that known load can indicate when the charging process should terminate. In one example, the switch is an e-switch.

One example of a charge progress component is a system that applies a known load to the cell being tested more than one time. One known load test can be accomplished using a resistor (or other dissipative element) in series with an electrical switch (physical or electronically actuated) to ground. When the switch is changed to a conductive state, the cell is under a known load, and repeated measurement of the resulting voltage drop across that known load over time can indicate when the charging process should terminate. In one example, the switch is an e-switch.

During operation, a self diagnostic feature may ensure that all system components are working properly.

One example of a self diagnostic feature is a component that can diagnose errors in the system. It may be necessary, for the execution of this self-diagnostic test, for the user to fill the system with any number of source cells or target cells of known states of charge. The self diagnostic feature may perform a number of steps. First, the system may provide a multitude of predetermined system state indicators to the user interface so an observer can ensure that all components of the user interface are functional. For example, the system can turn on all LEDs that are in the user interface in a sequential pattern so as to demonstrate they are all functional and connected properly. Next the system may enable all system powering components separately in a sequential fashion. If any of the powering components is not functioning properly, the self diagnostic component will detect this, and communicate it to the user via the user interface. One way of determining failure of a system powering component is loss of system power. The system may also command the charging control component to provide energy at a certain rate to a certain target cell or cells. Observing the output of the charge monitoring component will indicate if the charging control component and charge monitoring component are functioning properly.

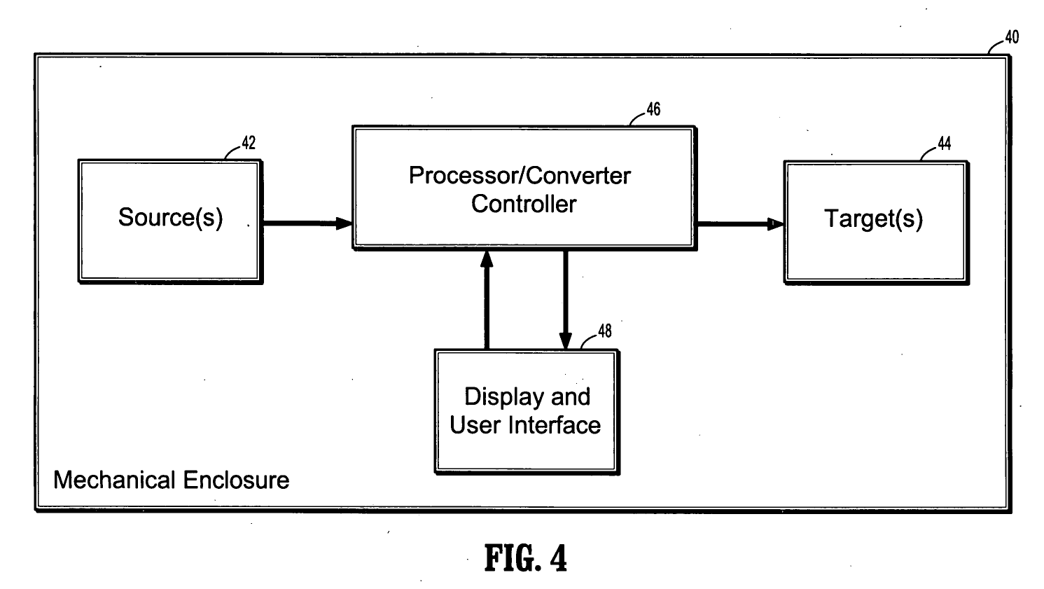

FIG. 4 depicts a schematic set of components of the system according to an illustrated embodiment of the invention. Energy flows from sources 42 to targets 44, as controlled by the controller 46. The controller 46 provides feedback via the user interface 48, and the user can interface with the system (controller 46) via the user interface 48. The system is housed in the mechanical enclosure 40.

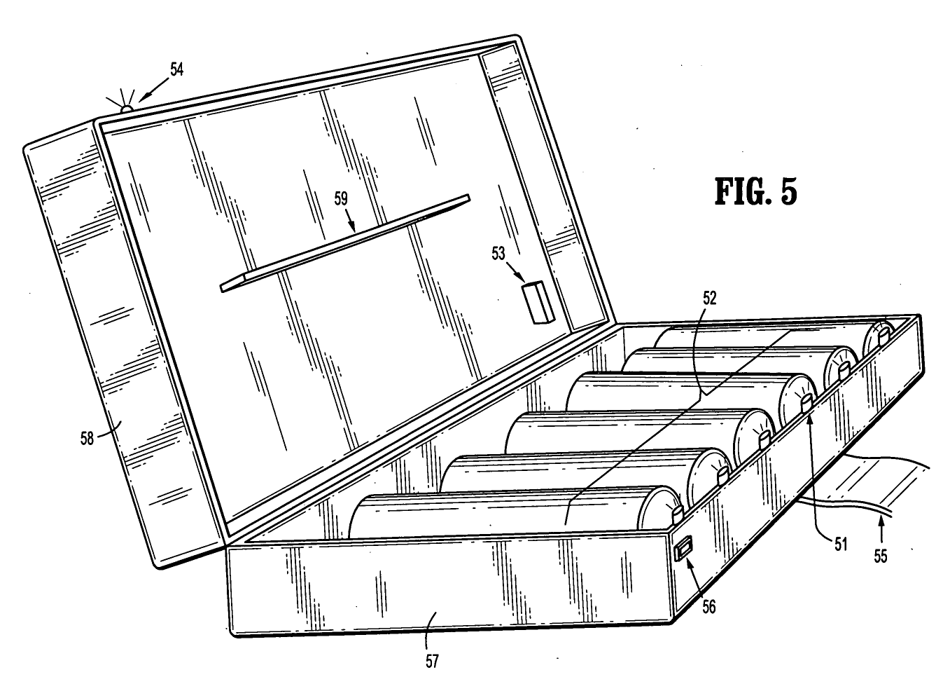

FIG. 5 depicts an illustrative embodiment of the proposed invention. A rectangular enclosure 57, 58 houses the system. In this case, the electronics and controller are housed beneath the cells 52. The illustrative enclosure consists of a hinged lid 58 which is held shut by a hook-and-loop strap 55. The lid can include a cell retention feature 59, which serves to hold the cells securely in place when the lid is closed. A magnetic switch 53 can automatically activate the user interface indicator LEDs 51, 54 when the lid is opened. The individual cell indicator LEDs 51 can be automatically turned off when the lid is closed. A system status indicator LED 54 can be always active, and can provide feedback about the system status while the lid is closed. A button or switch can be accessible while the enclosure is closed or open, and can serve to turn the system on or off. The switch may also serve to activate or de-activate the user interface LEDs.

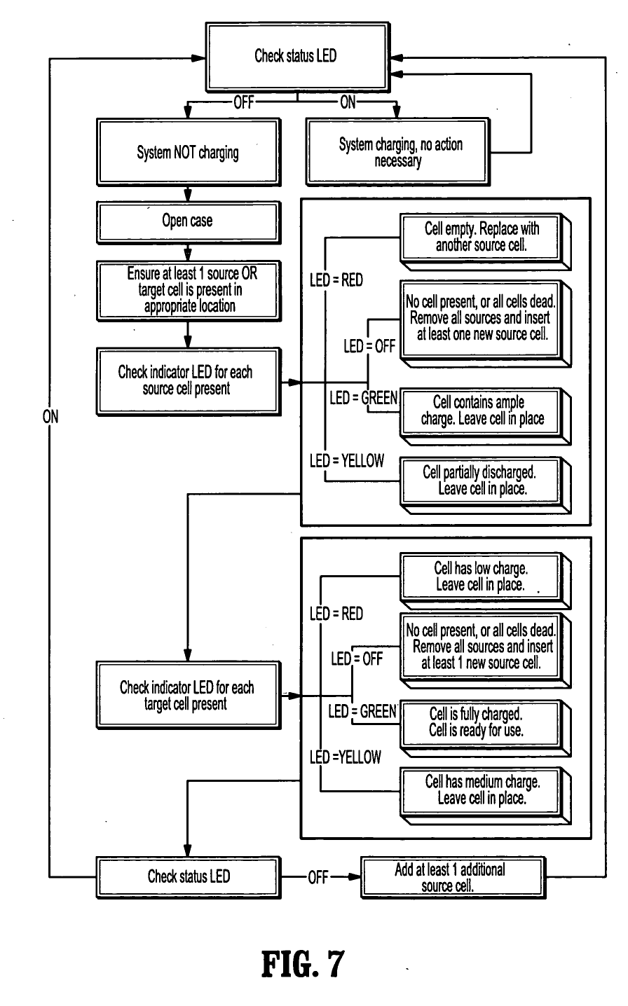

In an illustrative embodiment, the device and user interface function according to the operational flow chart shown in FIG. 7.

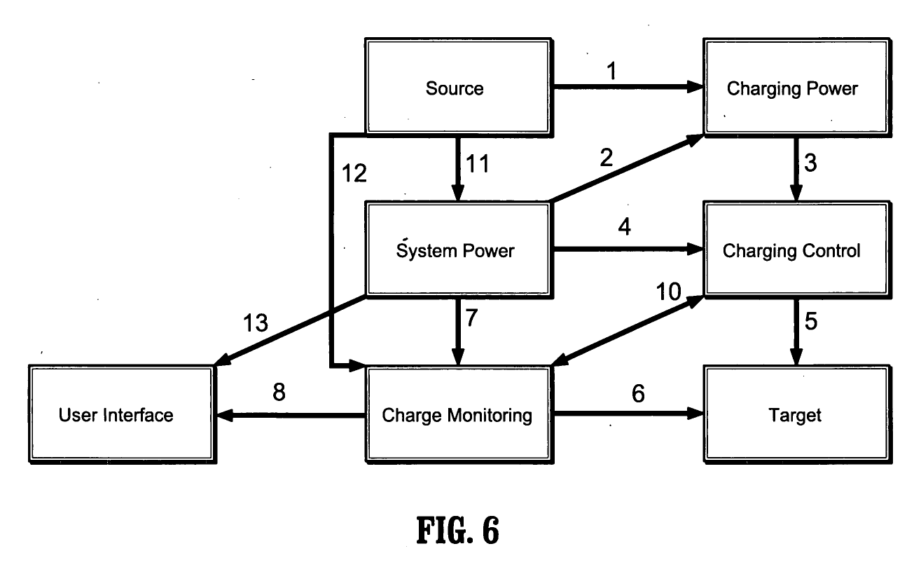

FIG. 6 depicts an overall system schematic demonstrating a configuration and algorithm for the system powering, operation, and charging scheme. The source block depicts a source cell. Element 61 represents the flow of energy from the source cell into the Charging Power block. Element 71 represents the flow of energy from the source cell into the System Power block. In this embodiment, the source cell provides both power for charging the target cell through 61 and powering the system through 71. It is possible for both of these blocks to be combined as a single block that both provide power for charging and running the system.

Connections 62, 64, 67, and 73 are provided to make enough power available to run the various components of the system. Connection 70 allows the charge monitoring component to both measure, and adjust the charging rate. Connection 63 provides energy into the charging control which imparts it to the targets through 65. Connections 66 and 72 enable the charge monitoring component to monitor the state of charge for the target cells and source cells, respectively. Connection 68 allows the charge monitoring component to update the user interface to reflect the state of the targets and sources.

The source block may be comprised of multiple cells. In the case there are multiple source cells, there may be multiple charging power blocks. The target block may be comprised of multiple cells. In the case there are multiple target cells, there may be multiple charging control blocks. It is also possible for the charging control block to individually address the target cells through a connection 65 for each cell.

Although the embodiment depicted in FIG. 6 is described as receiving system power from source cells, it should be understood that system power can alternatively or additionally be received from target cells and/or from an independent power source.

FIG. 7 provides a functional block diagram describing an exemplary system including red, green, and yellow LEDs in the user interface and describing how these LEDs are used to indicate the system status. The illumination of a status LED indicates that the system is on and energy is being transferred from source cells to target cells. If the status LED is off the system is not charging, in which case, the housing can be opened to ensure that at least one source cell or target cell is present in the appropriate location. Each source cell present has an indicator LED wherein a red indicator indicates an empty cell, a green indicator indicates a cell having ample charge, a yellow indicator indicates a cell that is partially discharged and a non-illuminated indicator indicates that no cell is present or all cells are dead. The exemplary system includes an indicator LED for each target cell present wherein a red indicator indicates that a target cell has low charge and should be left in place, a green indicator indicates that a cell is fully charged and ready for use, a yellow indicator indicates that a cell has medium charge and should be left in place. A non-illuminated indicator of a target cell indicates that no cell is present or all cells are dead.

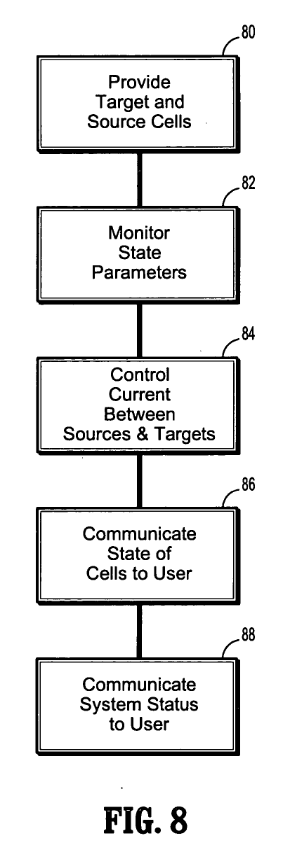

FIG. 8 depicts a method for extracting residual charge from energy storage devices according to an illustrative embodiment of the invention. The method includes the steps of providing 80 at least one rechargeable target cell in communication with at least one source cell, monitoring 82 state parameters of the at least one source cells and the at least one target cells, and controlling 84 current between source cells and target cells by causing or impeding current flow between the source cells and the target cells as a function of state parameters. The illustrative method also includes the step of providing a user interface to communicate a state of at least one cell to a user 86 and to communicate system status to a user 88.

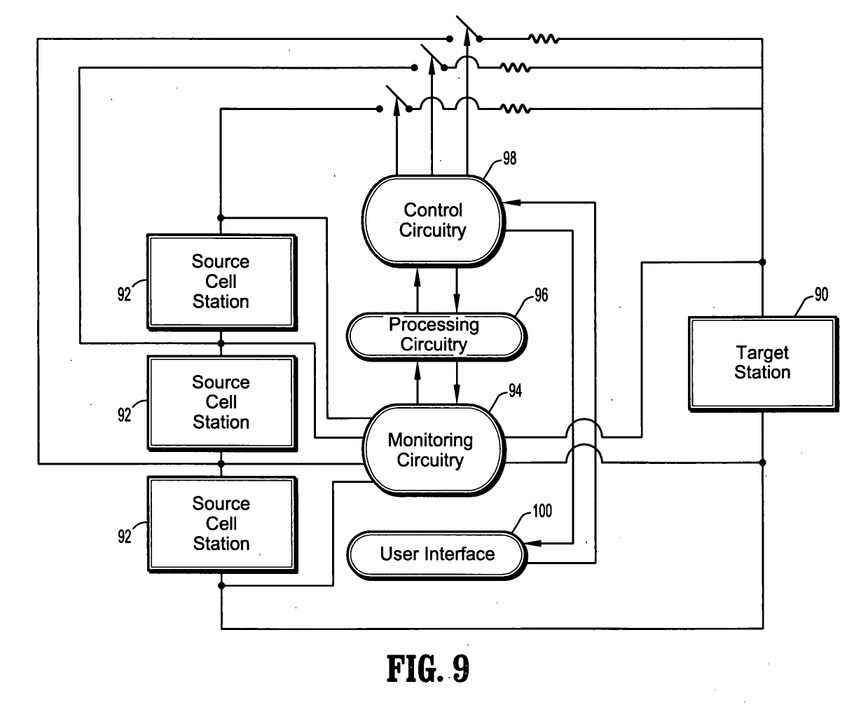

FIG. 9 depicts an apparatus for extracting residual charge from energy storage devices according to an illustrative embodiment of the invention. The depicted embodiment includes at least one target cell station 90 in communication with at least one source cell station 92. Monitoring circuitry 94 is provided in communication with the target cell station(s) 90 and the source cell station(s) 92. Processing circuitry 96 is provided in communication with the monitoring circuitry 94. Control circuitry 98 is provided in communication with the processing circuitry 96 and a user interface 100 is provided in communication with the control circuitry 98.

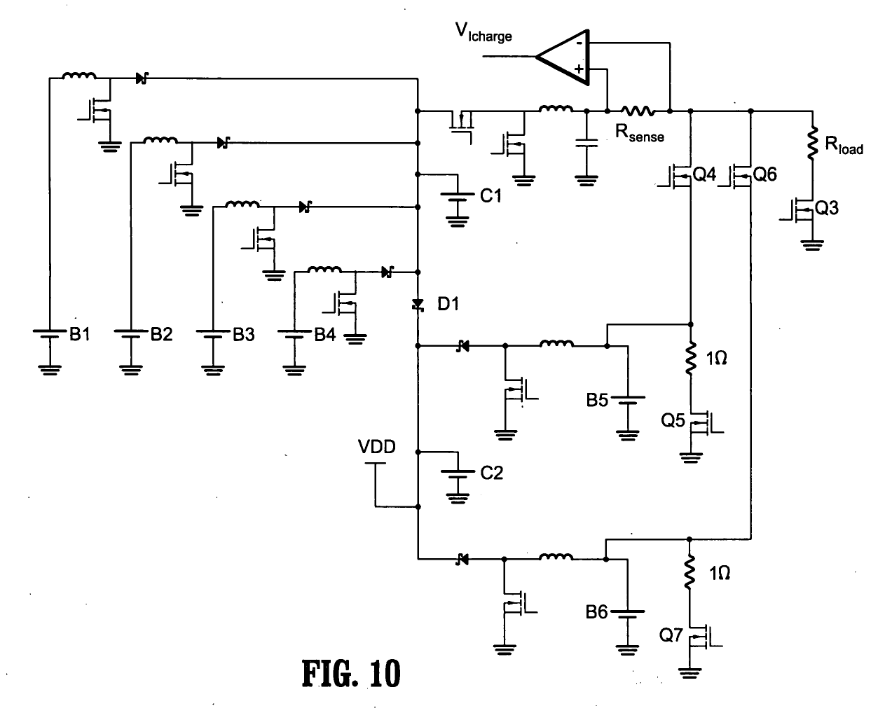

FIG. 10 depicts a particular illustrative embodiment of the invention. The illustrative embodiment depicted in FIG. 10 has four source batteries (B1-B4) and two target batteries (B5, B6). Each cell can power a 3.3V boost converter (TPS61000) to supply the operating voltage VDD.

B5 and B6 can be charged by a MAX8506 buck converter. D1 prevents the boost converters on B5 and B6 from supplying charging current to the buck. The output voltage of the buck can be controlled by a PIC18 microcontroller (not shown). The output current of the buck is measured with the current sensing resistor, Rₛₑₙₛₑ, and a differential amplifier. The PIC can adjust the output voltage of the MAX8506 to achieve the desired charging current. The PIC selects which cell to charge, B5 or B6, by turning Q4 or Q5 on respectively.

The PIC can determine the state-of-charge (SOC) of each cell by using one of three provided test loads. To determine the SOC of B1-B4, the PIC connects R_{load} to the output of the buck by turning on Q3, and then measures the voltage of the cell. Q5 and Q7 are used in a similar manner to determine the SOC of cells B5 and B6. Although, not shown in FIG. 10, it should be understood that a test load can also be placed on each of the source cells.

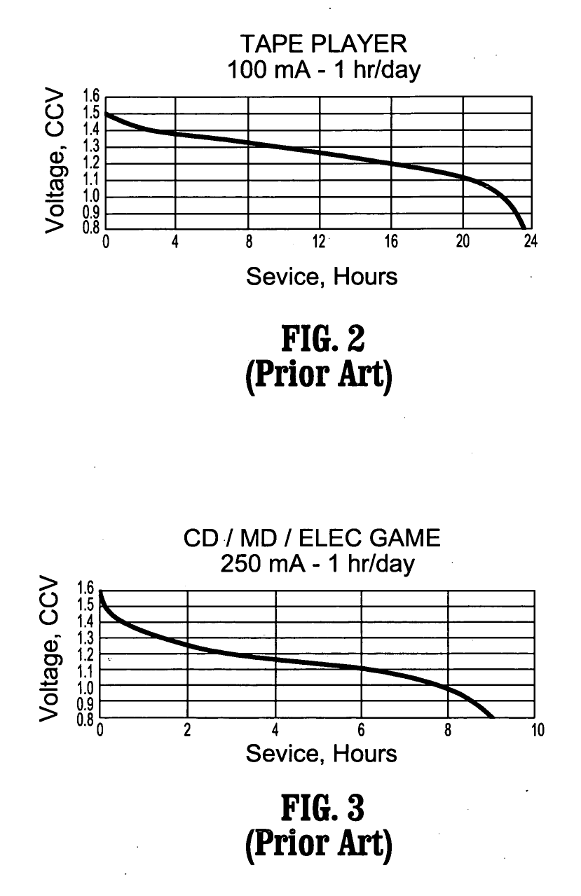

The device will have a red and green LED for each cell which the PIC can illuminate to indicate the SOC of each cell. However, in the case that none of the inserted cells are charged enough for any of the boost converters to operate, a second red LED is used to indicate a low SOC, as shown in FIG. 2.

This LED is a much smaller load compared to the rest of the circuit. Therefore, cells that are normally too weak to power-up the PIC supply may be able to illuminate this LED to provide and indication that the battery is low.

It should be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for extracting residual charge from energy storage devices comprising:
providing at least one rechargeable target cell in communication with at least one source cell;
monitoring state parameters of the at least one source cells and the at least one target cells; and
causing or impeding current flow between the at least one source cells and the at least one target cells as a function of the state parameters.

2. The method according to claim 1 wherein the target and source cells comprise batteries.

3. The method according to claim 1 wherein monitoring comprises providing connections between at least one source cell and/or at least one target cell and measuring circuitry.

4. The method according to claim 1 wherein the state parameters are members of a group consisting of open circuit voltage, closed circuit voltage, current through, temperature, rate of voltage change, elapsed charging time, and rate of current change.

5. The method according to claim 1 wherein the source cells are connected to each other in series.

6. The method according to claim 1 wherein the source cells are arranged in parallel with each other.

7. The method according to claim 1 wherein the target cells are arranged in parallel with each other.

8. The method according to claim 1 wherein causing current flow comprises closing a circuit between at least one source cell and at least one target cell using an electromechanical switch.

9. The method according to claim 1 wherein causing current flow comprises closing a circuit between at least one source cell and at least one target cell using a solid state switching device.

10. The method according to claim 1 wherein causing current flow comprises boosting a voltage across at least one source cell.

11. The method according to claim 1 wherein impeding current flow comprises opening a circuit between at least one source cell and at least one target cell using an electromechanical switch.

12. The method according to claim 1 wherein impeding current flow comprises opening a circuit between at least one source cell and at least one target cell using a solid state switching device.

13. The method according to claim 1 wherein impeding current flow comprises bucking a voltage across at least one source cell.

14. The method according to claim 1 wherein impeding current flow comprises regulating current flow using a linear regulator.

15. An apparatus for extracting residual charge from energy storage devices comprising:
at least one target cell station in communication with at least one source cell station;
monitoring circuitry in communication with a target cell station and a source cell station;
processing circuitry in communication with said monitoring circuitry; and
control circuitry in communication with the processing circuitry;
wherein the control circuitry comprises means for controlling flow of energy from at least one source cell in the source cell station to at least one target cell in the target cell station.

16. The apparatus according to claim 15 wherein the monitoring circuitry comprises means for measuring state parameters of at least one target cell or source cell in said target cell station or said source cell station.

17. The apparatus according to claim 16 wherein said state parameters are members of a set consisting of open circuit voltage, closed circuit voltage, current through, temperature, rate of voltage change, elapsed charging time, and rate of current change.

18. The apparatus according to claim 16 wherein said processing circuitry comprises means for comparing the state parameters to predetermined limits and communicating control signals to the control circuitry as a function of the comparison.

19. The apparatus according to claim 16 wherein said processing circuitry comprises means for determining control signal status as a function of the state parameters.

20. The apparatus according to claim 15 wherein the means for controlling flow of energy include charging power components selected from the group consisting of boost converters, linear regulators, buck converters and transformers.

21. A method for extracting residual charge from energy storage devices comprising:
providing at least one rechargeable target cell in communication with at least one source cell;
monitoring state parameters of the at least one source cells and the at least one target cells;
causing or impeding current flow between the at least one source cells and the at least one target cells as a function of state parameters; and
providing a user interface to communicate a state of at least one cell to a user.

22. The method according to claim 21 wherein the at least one state is a member of a set consisting of cell fully charged, cell partially charged, cell fully discharged.

23. The method according to claim 22 wherein the user interface includes outputs from the set consisting of visual outputs, audible outputs and tactile outputs.

24. The method according to claim 22 wherein the user interface includes colored light elements that are controlled to indicate the state of at least one of the cells.

25. The method according to claim 24 wherein a first color indicates cell fully charged, a second color indicates cell partially charged and a third color indicates cell fully discharged.

26. The method according to claim 23 wherein outputs are associated with each target cell and source cell.

27. The method according to claim 21 further comprising communicating system status to a user.

28. The method according to claim 27 wherein the system status is a member of a set consisting of energy being transferred, energy not being transferred, and system error.

29. An apparatus for extracting residual charge from energy storage devices comprising:
at least one target cell station in communication with at least one source cell station;
monitoring circuitry in communication with target cell station and the source cell station;
processing circuitry in communication with said monitoring circuitry;
control circuitry in communication with the processing circuitry; and
a user interface in communication with the control circuitry,
wherein the user interface includes at least one output device and wherein the control circuitry comprises means for controlling power to the output device(s) to communicate a state of at least one cell to a user.

30. The apparatus according to claim 29 wherein the at least one state is a member of a set consisting of cell fully charged, cell partially charged, and cell fully discharged.

31. The apparatus according to claim 29 wherein the user interface includes output devices from the set consisting of visual output devices, audible output devices and tactile output devices.

32. The apparatus according to claim 29 wherein the user interface includes colored light elements that are controlled to indicate the state of at least one of the cells and wherein a first color indicates cell fully charged, a second color indicates cell partially charged and a third color indicates cell fully discharged.

33. The apparatus according to claim 29 wherein output devices are associated with each target cell and source cell.

34. The apparatus according to claim 29 further comprising means to communicate system status to a user, wherein the system status is a member of a set consisting of energy being transferred, energy not being transferred, and system error.

35. The apparatus according to claim 30 wherein the user interface includes:
colored light elements that are controlled by the control circuitry to indicate the state each of the cells and wherein a first color indicates cell fully charged, a second color indicates cell partially charged and a third color indicates cell fully discharged; and
means to communicate system status to a user wherein the system status is a member of a set consisting of energy being transferred, energy not being transferred, and system error.

36. The apparatus according to claim 35 further comprising a housing enclosing said target cell station(s), said source cell station(s), said monitoring circuitry, said processing circuitry, said control circuitry and said user interface, wherein the colored light elements are powered only when the enclosure is open and wherein the means to communicate system status are readable by a user when the enclosure is closed.

37. The apparatus according to claim 36 wherein the user interface further comprises at least one input device in communication with the processing circuitry and/or the control circuitry and configured to enable or disable at least one of the output devices.

38. The apparatus according to claim 36 wherein the user interface further comprises at least one input device in communication with the processing circuitry and/or the control circuitry and configured to enable or disable energy transfer between the source cell(s) and the target cell(s).

39. The apparatus according to claim 29 wherein the user interface includes a system status indicator that indicates whether the system is charging, not charging, experiencing an error, experiencing a device failure, experiencing an individual cell problem, and wherein the system status indicator provides diagnostic information indicating charging rate, system current, charge history, charge time remaining, elapsed time, temperature, system settings a self-diagnostic state or cell test results.

40. The apparatus according to claim 29 wherein the user interface includes at least one individual cell indicator that provides information about the status of the system and the status of at least one individual cell.

41. The apparatus according to claim 40 wherein an individual cell indicator indicates whether the system is charging, not charging, experiencing an error, experiencing a device failure, experiencing an individual cell problem, or wherein the individual cell indicator indicates charging rate, system current, charge history, charge time remaining, elapsed time, temperature, system settings a self-diagnostic state or cell test results, energy level in each cell or individual cell voltage, group cell voltage, cell damage or anomaly, cell in self-test mode, elapsed time or time remaining, cell polarity incorrect, no cell present, cell requiring replacement, cell current, correct or incorrect cell chemistry or cell charge status.

42. The apparatus according to claim 29 further comprising at least one system status indicator or cell status indicator which communicates status information or cell status information according to a flashing frequency or duty cycle of the indicator.

43. The apparatus according to claim 29 wherein the at least one source cell station and the at least one target cell station are modular components that can be added or removed to change the number of stations in the apparatus.

44. The apparatus according to claim 29 wherein the user interface is located remotely from the source cell stations and target cell stations and wherein communication to the user interface is provided by wireless means.

45. The method according to claim 1 wherein the target cells are sequentially charged.
